(19) United States
(12) Patent Application Publication
(10) Pub. No.: US 2018/0063481 A1
(43) Pub. Date: Mar. 1, 2018

(54) HUMAN INTERFACE DEVICE (HID) BASED CONTROL OF VIDEO DATA CONVERSION AT DOCKING STATION

(71) Applicant: MICROSOFT TECHNOLOGY LICENSING, LLC, Redmond, WA (US)

(72) Inventors: Mengxi Yu, Redmond, WA (US); Gordon Free, Redmond, WA (US)

(73) Assignee: MICROSOFT TECHNOLOGY LICENSING, LLC, Redmond, WA (US)

(21) Appl. No.: 15/367,244

(22) Filed: Dec. 2, 2016

Related U.S. Application Data
(60) Provisional application No. 62/382,681, filed on Sep. 1, 2016.

(51) Int. Cl. H04N 7/15; H04L 29/06

(52) U.S. Cl. CPC H04N 7/15; H04L 65/403; H04L 65/601

(57) ABSTRACT

HID based control of video data conversion at a tablet docking station configurable as adapter for video conference systems is provided. HID protocol may be used for additional host control functions for a docking station in tele-conferencing applications such as host notifications and control of an interface that facilitates communication between video conference system and a tablet or similar computing device. The tablet HID side may handle communication. A descriptor table for allowing custom commands and instructions to be exchanged may reside at the docking station. For example, the custom HID protocol may provide host notifications for events such as HDMI connect, HDMI disconnect, as well as video resolution change.

### CROSS-REFERENCE TO RELATED APPLICATION

This application claims priority under 35 U.S.C. §119 of U.S. Patent Provisional Application No. 62/382,681 filed on Sep. 1, 2016. The U.S. Patent Application is herein incorporated by reference in its entirety.

### BACKGROUND

Video conference systems provide a much needed functionality to users. Participants across the globe can hold meetings face-to-face, share data, make presentations, etc. without the need for multiple people to travel long distances. While video conference systems typically provide reliable and satisfactory experience to users, many such systems require sophisticated and expensive equipment.

On the other hand, multimodal, online communication applications such as Skype® and Skype For Business® by MICROSOFT CORPORATION of Redmond, Wash., provide a much more reasonable (in terms of complication and cost) alternative to expensive video conference systems. However, online communication applications are typically directed to a user experience that involves the user's computer display and its peripherals, thus, not lending itself to conference room type environments.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to human interface device (HID) based control of video conference data conversion at a docking station. In some examples, availability of video conference data may be detected through a video data port of a docking station. Availability of an online communication application at a computing device connected to the docking station may also be detected. Next, participation of the online communication application in a video conference may be established by converting the video conference data to one or more media streams at the docking station based on a selection of video format by the online communication application and providing the media stream to the computing device through a serial data port. HID notification signals may be used as control signals associated with the video conference.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates a display diagram of an example video conference system communicatively coupled to a tablet and docking station among other devices;

FIG. 2 illustrates an example meeting device comprising a computer (tablet device) and a docking station configured to be an adapter for video conference systems using HID based control of video data conversion;

FIGS. 3A and 3B illustrate an example flow of operations in HID based control of video data conversion at a docking station;

FIG. 4 is an example networked environment, where a system according to embodiments may be implemented;

FIG. 5 is a block diagram of an example general purpose computing device, which may be configured to work with a tablet docking station configurable to provide HID based control of video data conversion; and

FIG. 6 illustrates a logic flow diagram of a method to utilize a tablet docking station for HID based control of video data conversion.

### DETAILED DESCRIPTION

As briefly described above, HID based control of video data conversion may be employed at a tablet docking station configurable as adapter for video conference systems. HID protocol may be used for additional host control functions for a docking station in tele-conferencing applications such as host notifications and control of an interface that facilitates communication between video conference system and a tablet or similar computing device. The tablet HID side may handle communication. A descriptor table for allowing custom commands and instructions to be exchanged may reside at the docking station. For example, the custom HID protocol may provide host notifications for events such as HDMI connect, HDMI disconnect, as well as video resolution change.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While some embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable memory device includes a hardware device that includes a hard disk drive, a solid state drive, a compact disk, and a memory chip, among others. The computer-readable storage medium can for example be implemented via one or more of a volatile computer memory, a non-volatile memory, a hard drive, and a flash drive.

Throughout this specification, the term “platform” may be a combination of software and hardware components for providing tablet docking stations configurable as adapters for video conference systems. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example embodiments may be found in the following description.

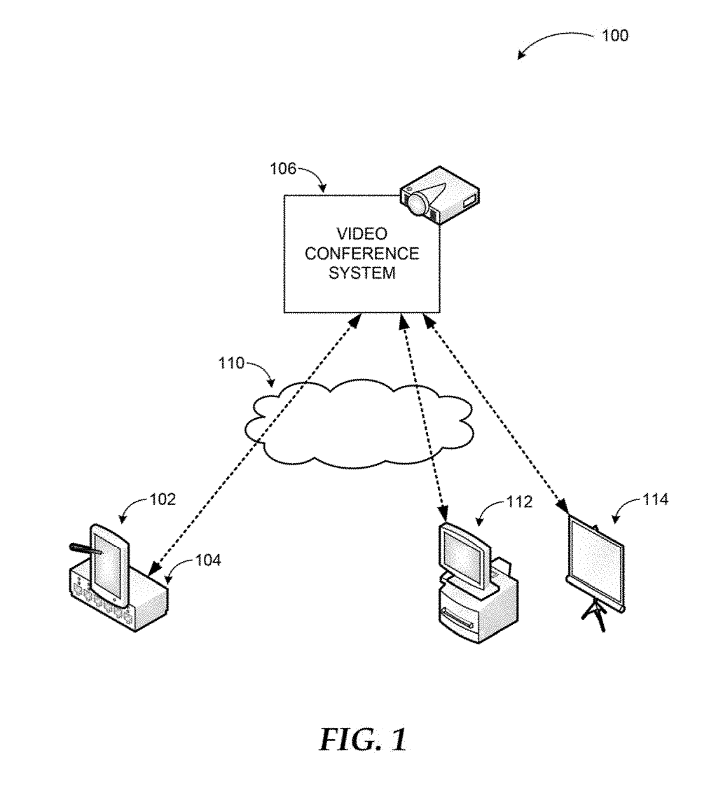

FIG. 1 illustrates a display diagram of an example video conference system communicatively coupled to a tablet and docking station among other devices, arranged in accordance with at least some embodiments described herein.

As shown in diagram 100, a tablet docking station configurable as adapter for a video conferencing system may provide suitable hardware and software interconnects to a tablet of similar computing device, thereby, allowing a user to join a video conference system 106 through their online communication application. Thus, a tablet computer 102 may be turned through a docking station 104 instantly into a meeting device providing a familiar and instantly recognizable meeting experience for a variety of meeting spaces. The user may be comfortable in the same way as they are with a dial pad. A meeting device according to example embodiments may include a computer with touch screen (e.g., a tablet device), a custom docking station to secure the computer, and audio/video (A/V) peripherals. Interconnections in the docking station 104 may allow the tablet device 102 to receive a media stream (used by the online communication application) that is received at the docking station 104 as video conference data from a video conference system 106 over one or more networks 110. The multimedia stream may be provided to the tablet device 102 through a serial data port. Similarly, media stream from the tablet device's serial data port may be converted to video conference data at the docking station and transmitted to the video conference system. Multiple media streams may be provided following a format of the video conference data. The video conference system 106 may also include other special purpose devices such as a specialty monitor 112 and a projection system 114, for example.

In some embodiments, upon detecting availability of video conference data at a video port and an online communication application at a computing device connected to the docking station, the docking station may establish participation of the online communication application in a video conference by converting the video conference data to one or more media streams based on a selection of video format by the online communication application and converting a media stream from the online communication application to video conference data. The docking station may use HID notification signals as control signals associated with the video conference to instruct the online communication application.

The technical advantages of a tablet docking station employing HID notification signals as control signals associated with the video conference may include, among others, improved performance, reduced processing and network bandwidth usage, and improved user interaction by allowing enhanced features of video conference systems to be accessible through online communication applications.

Embodiments, as described herein, address a need that arises from very large scale of operations created by software-based services that cannot be managed by humans. The actions/operations described herein are not a mere use of a computer, but address results of a system that is a direct consequence of software used as a service offered in conjunction with large numbers of devices and users participating in online meetings and video conference systems.

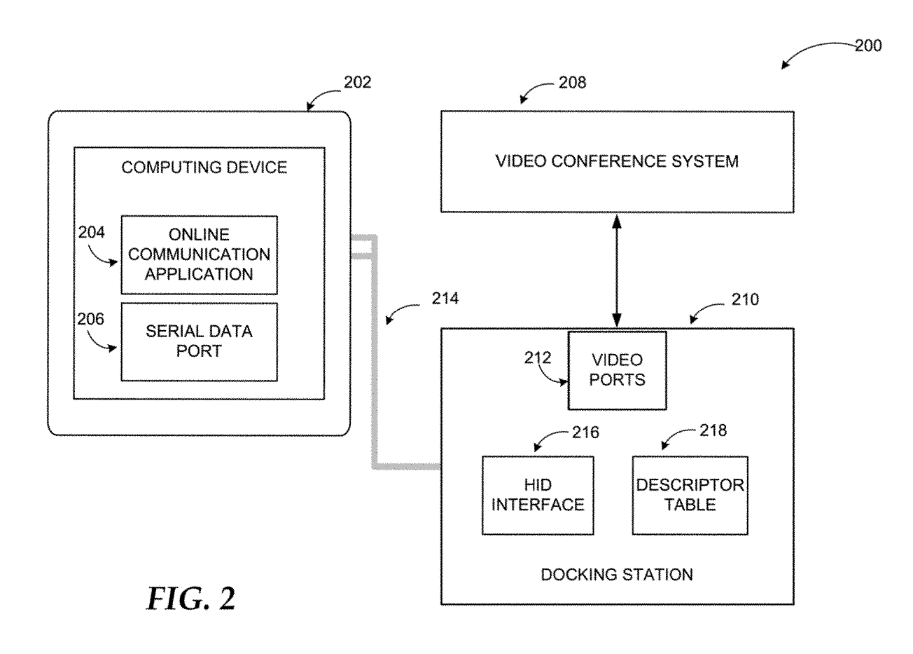

FIG. 2 illustrates an example meeting device comprising a computer (tablet device) and a docking station configured to be an adapter for video conference systems using HID based control of video data conversion.

A human interface device or HID is a type of computer device that interacts directly with, and most often takes input from, humans and may deliver output to humans. Interactions between a host device and an HID device is facilitated through the HID protocol. Using the HID protocol, operating systems may recognize HID devices, such as a keyboard or a mouse, without having to install a specialized driver. The HID protocol defines two entities: a host and a device. The device is the entity that directly interacts with a human. The host communicates with the device and receives input data from the device on actions performed by the human. Output data flows from the host to the device and then to the human. For example, a host may be a desktop computer and a peripheral device for human interaction connected to the desktop computer through a serial port may be the HID device.

In the HID protocol, devices define their data packets and then present a HID descriptor to the host. The HID descriptor is a hard coded array of bytes that describe the device's data packets. The HID descriptor may include how many packets the device supports, the size of the packets, and the purpose of each byte and bit in the packet. For example, a keyboard with a calculator program button can tell the host that the button's pressed/released state is stored as the 2nd bit in the 6th byte in data packet number 4. Simpler HID devices may store their HID descriptor in non-volatile memory and may not need to process it, just provide to the host. The host may typically retrieve the HID descriptor from the device and parse it before establishing communication with the device. In some cases, the HID descriptor may be in form of a HID descriptor table, that is, the meaning of the bytes and bits associated with a particular device may be provided as a table that describes a size and a purpose of each data field.

As shown in diagram 200, a meeting device according to embodiments may include a tablet or similar computing device 202 capable of executing an online communication application 204 such as Skype® and Skype For Business® by MICROSOFT CORPORATION of Redmond, Wash. The tablet or similar computing device 202 may include one or more serial data ports 206 such as Universal Serial Databus (USB), some of which may be capable of handling different data rates. In some operation configurations, the tablet or similar computing device 202 may be operated connected to a docking station 210, which may provide a simplified way of interconnectivity with peripheral devices, networks, provide power to the tablet or similar computing device 202, and enable interconnectivity with a video conference system 208.

A number of connections may be provided between the tablet or similar computing device 202 and the docking station 210, for example, to exchange network data communications, audio/video signals, and other control signals. In some examples, a serial bus interconnector 214 may provide the connection with the tablet or similar computing device 202.

The docking station may provide one or more video data input ports 212 to capture video and audio outputs from external sources such as video conference system 208 and comply with a number of standards. The docking station 210 may also convert the input video data into compliant media streams and transmit to the tablet or similar device through a serial data interface. If multiple serial data ports are available, one of them may be selected based on a data rate of the generated media stream(s). The video data input may support multiple video formats and/or multiple frame rates. The serial data port connection may support a main output video stream with the resolution same as video data input port's native resolution, in some examples. In other examples, a concurrent preview video stream with scaled down resolution may also be provided. Various frame rates and compressions may be supported while video controls may be based on the standard protocol of the serial data port.

According to some embodiments, a custom HID protocol may provide host notifications for events such as video conference data port connect or disconnect. HID notifications may also be used to wake up a suspended online communication application or exchange other control commands. An HID interface 216 may facilitate the exchange of HID signals through the serial data port of the table or similar computing device 202, while a HID descriptor table 218 may define the specific bytes and bits to be used for exchange of control commands in conversion of video data.

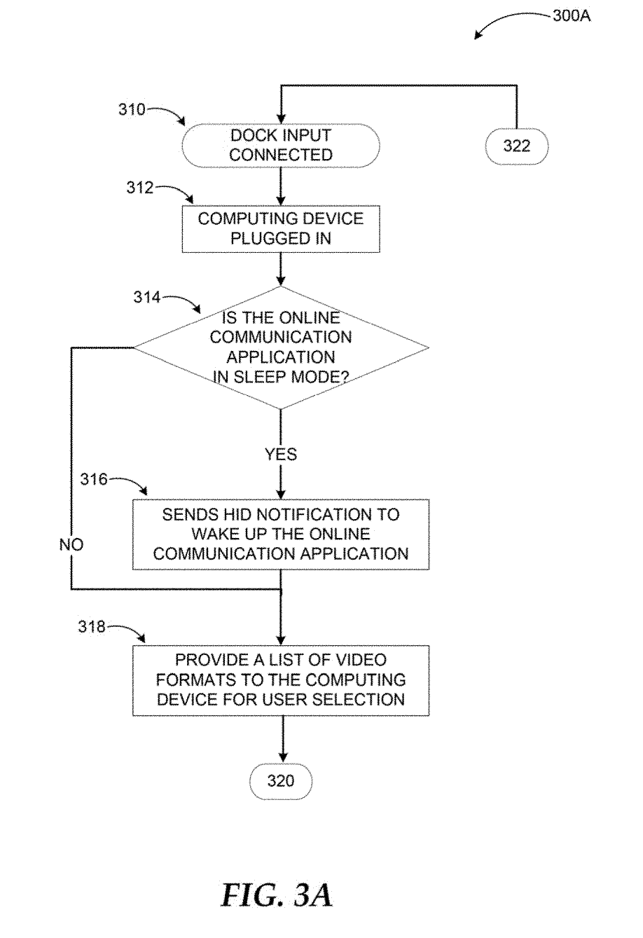

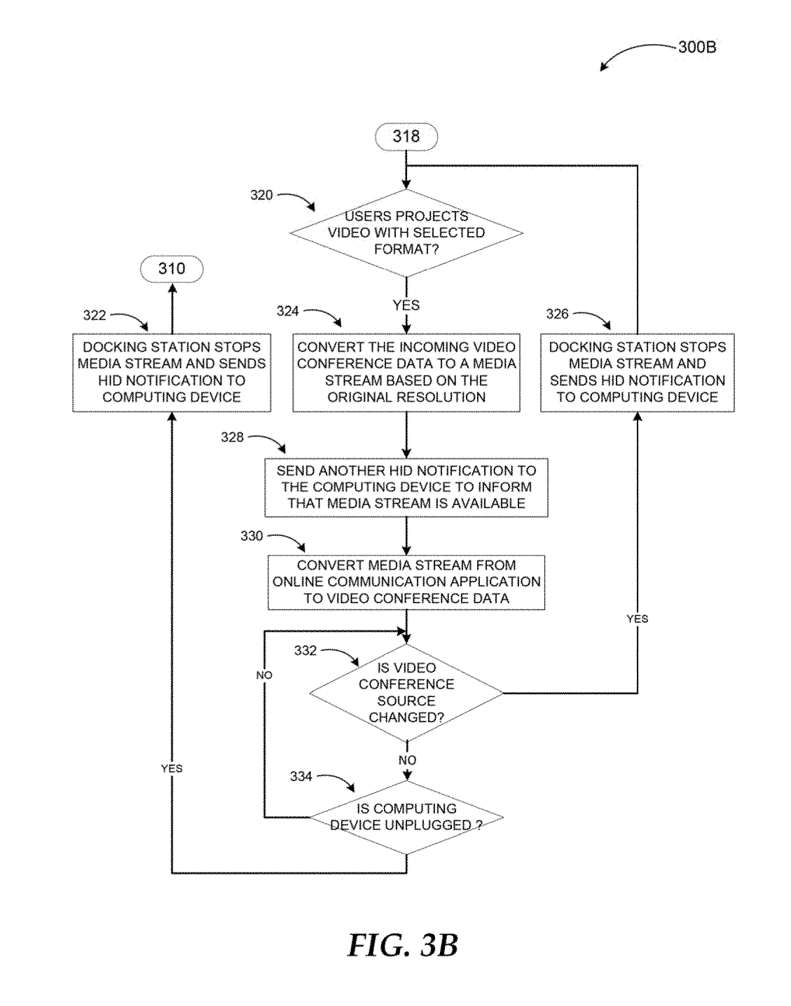

FIGS. 3A and 3B illustrate an example flow of operations in HID based control of video data conversion at a docking station.

The individual operation blocks of the example flows in diagrams 300A and 300B are for illustration purposes and are not intended to limit embodiments. Embodiments may be implemented with fewer or additional operation blocks and configurations using the principles described herein.

As shown in diagram 300A, operations at a docking station may begin with a video conference data port (e.g., HDMI) being connected to a video conference system (310). Upon detecting that the tablet or similar computing device being connected to a serial data port as well (312), the docking station may check to determine if the online communication application executed at the computing device is in a sleep or screen-off mode (314) (not active). If the decision is affirmative, the docking station may send an HID notification to the tablet or similar computing device to wake up the online communication application (316).

The tablet or similar computing device may determine which video formats are supported by the docking station by reading its data structure (318) and determine if the user is selecting one of the supported video formats (320) as shown in diagram 300B. If the decision is affirmative, the docking station may convert the incoming video conference data to a media stream based on the original resolution (324) and send another HID notification to the tablet or similar computing device to inform that media stream is available (328). The online communication application at the tablet or similar computing device may at that point open the serial data device (port) and stream the media (330) allowing the user to participate in a video conference hosted by a video conference system through the online communication application.

If during the conference, the video conference source changes (332), for example, new resolution, the docking station may stop the media stream and send an HID notification to the tablet or similar computing device (326) returning the process to operation 320. If the video conference data source is removed (e.g., unplugged) (334), the docking station may stop the media stream and send an HID notification to the tablet or similar computing (322) device returning the process to the beginning (operation 310).

While example operations and blocks are described using specific implementations such as USB and HDMI herein, embodiments are not limited to those and other standard or proprietary communication systems and conversions may also be implemented using the principles described here.

The docking station executing the custom HID protocol may provide one or more video data input ports (e.g., HDMI) to capture video and audio outputs from external sources and comply with a number of standards. The docking station may convert the input video data into compliant media streams (e.g., HDMI to UVC) and transmit to the tablet or similar device through a serial data interface. If multiple serial data ports are available, one of them may be selected based on a data rate of the generated media stream(s). The video data input may support multiple video formats, including, but not limited to, 640×480, 720×480, 800×600, 1024×768, 1280×720, 1280×800, 1280×960, 1280×1024, 1360×768, 1366×768, 1440×900, 1600×900, 1600×1200, 1680×1050, 1920×1080, 1920×1200. Multiple frame rates such as 25, 29.97, 30, 50, 59.94, 60 fps may also be supported.

The serial data port connection may support a main output video stream with the resolution same as video data input port's native resolution, in some examples. In other examples, a concurrent preview video stream with scaled down (e.g., 180P) resolution may also be provided. Various frame rates and compressions may be supported while video controls may be based on the standard protocol of the serial data port. In some embodiments, the docking station may notify the tablet or similar computing device via HID protocol messages when an active video data input is connected or disconnected. The docking station may provide an HID interface so that the tablet or similar computing device can query the connection status of video data input. The latency of the video data to serial data (e.g., HDMI to USB) conversion may be configured to remain below a predefined threshold such as 100 ms. In some examples, the conversion may not decrypt any protected content. Audio input through the video data port may also be converted to compliant media stream(s) and transmitted to the tablet or similar computing device via the selected serial data port.

The examples provided in FIGS. 1 through 3B are illustrated with specific systems, services, applications, modules, and codes. Embodiments are not limited to environments according to these examples. A tablet docking station configurable to provide HID based control of video data conversion may be implemented in environments employing fewer or additional systems, services, applications, engines, codes, and user experience configurations. Furthermore, the example systems, services, applications, and modules shown in FIG. 1 through 3B may be implemented in a similar manner with other values using the principles described herein.

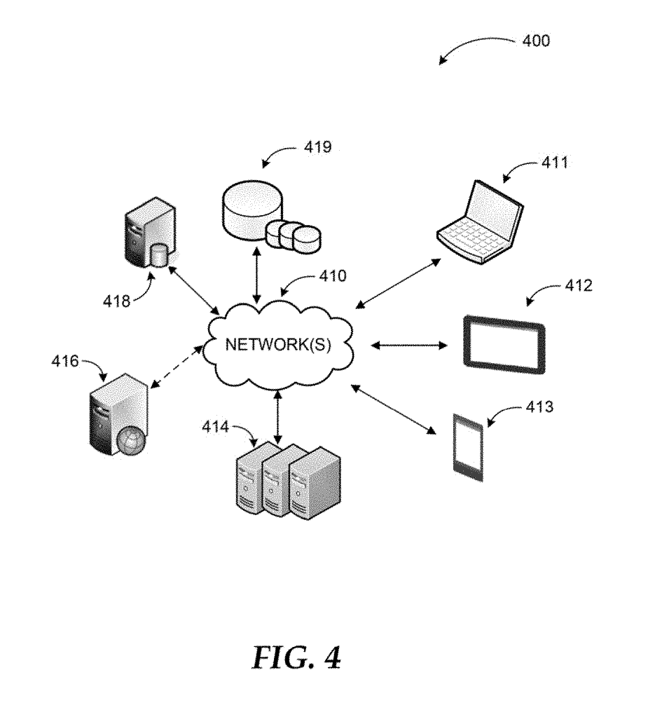

FIG. 4 is an example networked environment, where a system according to embodiments may be implemented.

As shown in a diagram 400, a video conference service may be implemented in a networked environment over one or more networks such as network 410. Users may access the service through locally installed or thin (e.g., browser) online communication client applications executed on a variety of computing devices with docking stations configured as adapters. Functionality within the video conference service environment may be provided by a communication module or application executed within the service executed on servers 414 or processing server 416.

A video conference service, as discussed herein, may be implemented via software executed over servers 414. The servers 414, may include one or more processing server 416, where at least one of the one or more processing servers 416 may be configured to execute one or more applications associated with the service. The service may store data associated with a meeting in a data store 419 directly or through a database server 418. The service may communicate with client applications on individual computing devices such as a laptop computer 411, a tablet computer 412 and a smart phone 413 through network(s) 410 and control a user interface presented to users.

The network 410 may comprise any topology of servers, clients, Internet service providers, and communication media. A system according to embodiments may have a static or dynamic topology. The network 410 may include multiple secure networks, such as an enterprise network, an unsecure network, or the Internet. The unsecure network may include a wireless open network. The network 410 may also coordinate communication over other networks, such as Public Switched Telephone Network (PSTN) or cellular networks. Furthermore, the network 410 may include multiple short-range wireless networks, such as Bluetooth, or similar ones. The network 410 may provide communication between the nodes described herein. By way of example, and not limitation, the network 410 may include wireless media. The wireless media may include, among others, acoustic media, RF media, infrared media, and other wireless media.

A textual scheme, a graphical scheme, an audio scheme, an animation scheme, a coloring scheme, a highlighting scheme, and/or a shading scheme may be employed to further enhance user interaction with a client interface of an online communication application integrated into a video conference service.

Many other configurations of the computing devices, the applications, the data sources, and the data distribution systems may be employed to provide HID based control of video conference data conversion at a docking station. Furthermore, the networked environments discussed in FIG. 4 are for illustration purposes only. Embodiments are not limited to the example applications, modules, or processes.

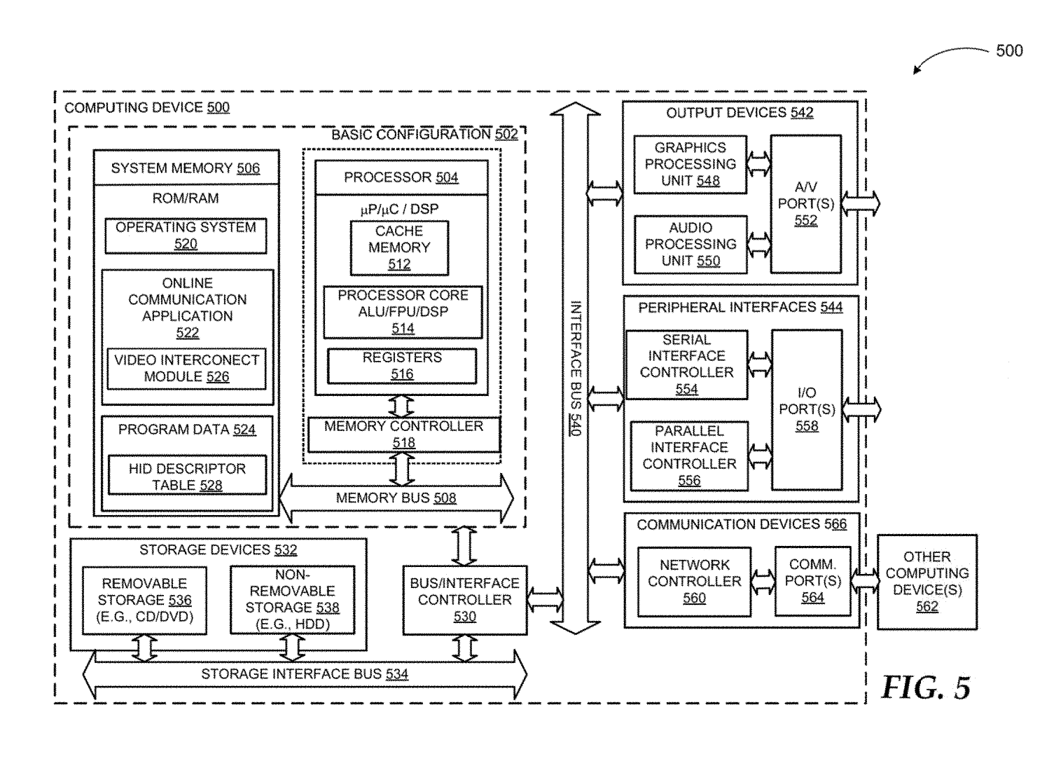

FIG. 5 is a block diagram of an example general purpose computing device, which may be configured to work with a tablet docking station configurable to provide HID based control of video data conversion.

For example, a computing device 500 may be a server, a desktop computer, or a special purpose device used to provide tablet docking stations configurable as adapters for video conference systems in conjunction with an online communication application 522, as discussed herein. In an example of a basic configuration 502, the computing device 500 may include a processor 504 and a system memory 506. The processor 504 may include multiple processors. A memory bus 508 may be used for communication between the processor 504 and the system memory 506. The basic configuration 502 may be illustrated in FIG. 5 by those components within the inner dashed line.

Depending on the desired configuration, the processor 504 may be of any type, including, but not limited to, a microprocessor (μP), a microcontroller (μC), a digital signal processor (DSP), or any combination thereof. The processor 504 may include one more levels of caching, such as a level cache memory 512, a processor core 514, and registers 516. The processor core 514 may include an arithmetic logic unit (ALU), a floating point unit (FPU), a digital signal processing core (DSP Core), or any combination thereof. A memory controller 518 may also be used with the processor 504, or in some implementations, the memory controller 518 may be an internal part of the processor 504.

Depending on the desired configuration, the system memory 506 may be of any type including but not limited to volatile memory (such as RAM), non-volatile memory (such as ROM, flash memory, etc.), or any combination thereof. The system memory 506 may include an operating system 520, an online communication application 522, and program data 524. The online communication application 522 may include a video interconnect module 526. The video interconnect module 526 may perform bidirectional transformation of video conference data and media streams used by the online communication application 522 with HID signaling used for exchange of control commands as described herein. Program data 524 may include, among others, HID descriptor table data 528.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and data storage devices 532 via a storage interface bus 534. The data storage devices 532 may be removable storage devices 536, non-removable storage devices 538, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 506, the removable storage devices 536, and the non-removable storage devices 538 may be examples of computer storage media. Computer storage media may include, but may not be limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 500. Any such computer storage media may be pan of the computing device 500.

The computing device 500 may also include an interface bus 540 for facilitating communication from various interface devices (for example, one or more output devices 542, one or more peripheral interfaces 544, and one or more communication devices 566) to the basic configuration 502 via the bus/interface controller 530. The one or more output devices 542 may include a graphics processing unit 548 and an audio processing unit 550, which may be configured to communicate to various external devices, such as a display or speakers via one or more A/V ports 552. The one or more peripheral interfaces 544 may include a serial interface controller 554 or a parallel interface controller 556, which may be configured to communicate with external devices, such as input devices (for example, keyboard, mouse, pen, voice input device, touch input device, etc.) or other peripheral devices (for example, printer, scanner, etc.) via one or more I/O ports 558. The one or more communication devices 566 may include a network controller 560, which may be arranged to facilitate communications with one or more other computing devices 562 over a network communication link via one or more communication ports 564. The one or more other computing devices 562 may include servers, client equipment, and comparable devices.

The network communication link may be one example of a communication media. Communication media may be embodied by computer-readable instructions, data structures, program modules, or other data in a modulated data signal, such as a carrier wave or other transport mechanism, and may include any information delivery media. A “modulated data signal” may be a signal that has one or more of the modulated data signal characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media, as used herein, may include both storage media and communication media.

The computing device 500 may be implemented as a part of a general purpose or specialized server, mainframe, or similar computer, which includes any of the above functions. The computing device 500 may also be implemented as a personal computer including both laptop computer and non-laptop computer configurations.

Example embodiments may also include methods to provide HID based control of video data conversion. These methods may be implemented in any number of ways, including the structures described herein. One such way may be by machine operations, using devices of the type described in the present disclosure. Another optional way may be for one or more of the individual operations of the methods to be performed in conjunction with one or more human operators performing some of the operations while other operations may be performed by machines. These human operators need not be co-located with each other, but each may be with a machine that performs a portion of the program. In other examples, the human interaction may be automated such as by pre-selected criteria that may be machine automated.

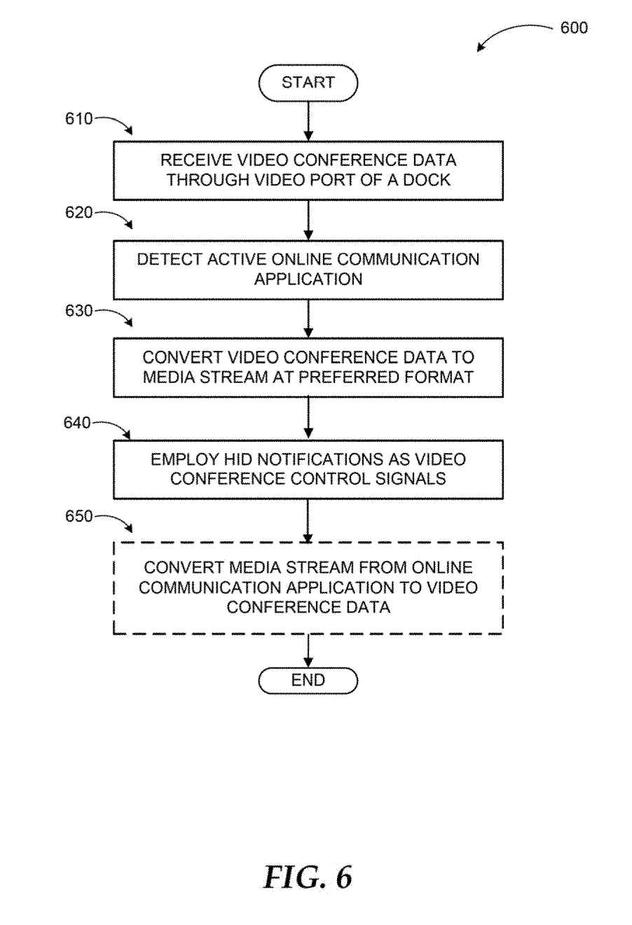

FIG. 6 illustrates a logic flow diagram of a method to utilize a tablet docking station for HID based control of video data conversion.

A process 600 may be implemented at a docking station configured to be an adapter for tablet devices and similar ones in order to allow online communication applications participate in video conferences.

At operation 610, video conference data according to a format of a video conference system may be received through a video port (e.g., HDMI) of a docking station. At operation 620, an active online communication application may be detected at the connected computing device. Upon detection of the active online communication application, the received video conference data may be converted to a media stream that is usable by an online communication application executed on a tablet or similar device connected to the docking station at operation 630.

At operation 640, HID notifications based on definitions in HID descriptor tables stored in the docking station may be used to exchange control commands such as waking up an inactive online communication application, notifying the online communication application about the available video conference data, receiving data rate information, etc. The media stream may be provided to the tablet or similar device through the detected/selected serial data port. At optional operation 650, one or more media streams (e.g., a main media stream and a low resolution preview media stream) may be received through the serial data port from the tablet or similar device and converted to video conference data to be provided to the video conference system.

The operations included in process 600 are for illustration purposes. HID based control of video conference data conversion at a docking station, according to embodiments, may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to examples, a means for providing human interface device (HID) based control of video conference data conversion at a docking station is described. The means may include a means for detecting availability of video conference data through a video data port of the docking station; a means for detecting availability of an online communication application communicatively connected to the docking station; and a means for establishing participation of the online communication application in a video conference by: converting the video conference data to one or more media streams at the docking station based on a selection of video format by the online communication application; providing the one or more media streams to the online communication application through one or more serial data ports; and employing HID notification signals as control signals associated with the video conference.

According to some examples, a method to provide human interface device (HID) based control of video conference data conversion at a docking station is described. The method may include detecting availability of video conference data through a video data port of the docking station; detecting availability of an online communication application communicatively connected to the docking station; and establishing participation of the online communication application in a video conference by: converting the video conference data to one or more media streams at the docking station based on a selection of video format by the online communication application; providing the one or more media streams to the online communication application through one or more serial data ports; and employing HID notification signals as control signals associated with the video conference.

According to other examples, the method may also include receiving one or more other media streams from the online communication application; converting the one or more other media streams from the online communication application to the video conference data at the docking station; and transmitting the video conference data to a video conference system. The change in the video conference data may include a change of resolution.

According to further examples, employing the HID notification signals as the control signals that associated with the video conference may include if the online communication application is in an inactive mode, sending a first HID notification to a computing device executing the online communication application to wake up the online communication application, sending a second HID notification to the computing device executing the online communication application to indicate availability of the one or more media streams, sending a third HID notification to the computing device executing the online communication application in response to detecting a change in the video conference data, and sending a fourth HID notification to the computing device executing the online communication application in response to detecting a disconnect at the video port of the docking station.

According to some examples, the HID notification signals may be defined according to a custom HID protocol in one or more HID descriptor tables stored at the docking station. The one or more HID descriptor tables may be provided to the computing device executing the online communication application.

According to other examples, a docking station configured as an adapter for video conference systems to provide human interface device (HID) based control of video conference data conversion is described. The docking station may include a video data input port configured to receive a video conference data according to a format of a video conference system; a video to serial port converter configured to convert the video conference data to one or more media streams; a serial data interface having a plurality of serial data ports to provide connectivity by a serial bus interconnector, wherein the serial bus interconnector is configured to provide the one or more media streams to an online communication application through one of the plurality of serial data ports; and a HID interface configured to employ HID notifications as control signals associated with establishing participation of an online communication application in a video conference.

According to some examples, the docking station may also include a motion sensor is configured to activate the online communication application through a HID notification. The HID interface may be configured to provide HID notifications in response one or more of: detecting the online communication application being in an inactive mode, detecting availability of the one or more media streams, detecting a change in the video conference data, and detecting a disconnect or a connect at the video port of the docking station, and to receive a HID notification associated with a selection of a video format by the online communication application.

According to further examples, the docking station may also include a display port converter to convert one or more other media streams from the online communication application to video signals. The one or more other media streams may include a main media stream and a low resolution preview media stream.

According to other examples, a system to provide a video conference service to a tablet device through a docking station employing human interface device (HID) based control of video conference data conversion is described. The system may include a tablet device comprising a memory, a display, one or more input devices, and a processor, the processor configured to execute an online communication application in conjunction with instructions stored in the memory; and a docking station coupled to the tablet device through at least a serial bus interconnector. The docking station may include a communication interface configured to facilitate communication between the tablet device and the video conference service through the docking station; a serial data port hub configured to manage exchange of signals between a plurality of docking station circuits and the tablet device; and a HID interface configured to employ HID notifications as control signals associated with establishing participation of the online communication application in a video conference, wherein the HID notification signals are defined according to a custom HID protocol in one or more HID descriptor tables stored at the docking station.

According to further examples, the docking station may also include a video interconnect circuit configured to convert a media stream from the tablet device through the detected serial data port to the video conference data and transmit the video conference data to the video conference system through a video output port. The HID interface may be further configured to provide the HID notifications in response one or more of detecting the online communication application being in an inactive mode, detecting availability of the one or more media streams, detecting a change in the video conference data, and detecting a disconnect or a connect at the video port of the docking station and receive a HID notification associated with a user selection of a video format by the online communication application.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

1. A method to provide human interface device (HID) based control of video conference data conversion at a docking station, the method comprising:
detecting, by a computing device executing an online communication application, availability of video conference data through a video data port of the docking station, wherein the computing device is connected to the docking station;
detecting availability of the online communication application at the computing device communicatively connected to the docking station;
establishing participation of the online communication application in a video conference by:
converting the video conference data to one or more media streams at the docking station based on a selection of video format by the online communication application;
providing the one or more media streams to the online communication application through one or more serial data ports; and
employing, through the one or more serial data ports, HID notification signals as control signals associated with the video conference, wherein employing the HID notification signals comprises:
transmitting a first HID notification signal to a computing device executing the online communication application to activate the online communication application in response to detecting the online communication application being in an inactive mode,
transmitting a second HID notification signal to a computing device executing the online communication application upon detecting availability of the one or more media streams, and
transmitting a third HID notification signal to a computing device executing the online communication application upon detecting a change in the video conference data.

2. The method of claim 1, further comprising:
receiving one or more other media streams from the online communication application;
converting the one or more other media streams from the online communication application to the video conference data at the docking station; and
transmitting the video conference data to a video conference system.

3.-5. (canceled)

6. The method of claim 1, wherein the change in the video conference data includes a change of resolution.

7. The method of claim 1, wherein employing the HID notification signals as the control signals associated with the video conference comprises:
sending a fourth HID notification to a computing device executing the online communication application in response to detecting a disconnect at the video port of the docking station.

8. The method of claim 1, wherein the HID notification signals are defined according to a custom HID protocol.

9. The method of claim 8, wherein the HID notification signals according to the custom HID protocol are defined in one or more HID descriptor tables stored at the docking station.

10. The method of claim 9, wherein employing the HID notification signals as the control signals associated with the video conference further comprises:
providing the one or more HID descriptor tables to a computing device executing the online communication application.

11. A docking station configured as an adapter for a video conference system to provide human interface device (HID) based control of video conference data conversion, the docking station comprises:
a video data input port configured to receive a video conference data according to a format of a video conference system;
a video to serial port converter configured to convert the video conference data to one or more media streams;
a serial data interface having a plurality of serial data ports to provide connectivity by a serial bus interconnector, wherein the serial bus interconnector is configured to provide the one or more media streams to an online communication application through one of the plurality of serial data ports; and
a HID interface configured to employ HID notifications signal as control signals associated with establishing participation of the online communication application in a video conference, wherein employ the HID notification signals comprises:
transmit a first HID notification signal to the online communication application to activate the online communication application in response to detecting the online communication application being in an inactive mode,
transmit a second HID notification signal to the online communication application upon detecting availability of the one or more media streams, and
transmit a third HID notification signal to the online communication application upon detecting a change in the video conference data.

12. The docking station of claim 11, further comprising:
a motion sensor is configured to activate the online communication application through a HID notification.

13. The docking station of claim 11, wherein the HID interface is further configured to provide HID notifications in response of:
detecting a disconnect or a connect at the video port of the docking station.

14. The docking station of claim 11, wherein the HID interface is further configured to receive a HID notification associated with a selection of a video format by the online communication application.

15. The docking station of claim 11, further comprising:
a display port converter to convert one or more other media streams from the online communication application to video signals.

16. The docking station of claim 15, wherein the one or more other media streams include a main media stream and a low resolution preview media stream.

17. A system to provide a video conference service to a tablet device through a docking station employing human interface device (HID) based control of video conference data conversion, the system comprising:
a tablet device comprising a memory, a display, one or more input devices, and a processor, the processor configured to execute an online communication application in conjunction with instructions stored in the memory; and
a docking station coupled to the tablet device through at least a serial bus interconnector, the docking station comprising:
a communication interface configured to facilitate communication between the tablet device and the video conference service through the docking station;
a serial data port hub configured to manage exchange of signals between a plurality of docking station circuits and the tablet device; and
a HID interface configured to employ HID notifications signals as control signals associated with establishing participation of the online communication application in a video conference, wherein the HID notification signals are defined according to a custom HID protocol in one or more HID descriptor tables stored at the docking station, and wherein employ the HID notification signals comprises:
transmit a first HID notification signal to the online communication application to activate the online communication application in response to detecting the online communication application being in an inactive mode,
transmit a second HID notification signal to the online communication application upon detecting availability of the one or more media streams, and
transmit a third HID notification signal to the online communication application upon detecting a change in the video conference data.

18. The system of claim 17, wherein docking station further comprises a video interconnect circuit configured to convert a media stream from the tablet device through the detected serial data port to the video conference data and transmit the video conference data to the video conference system through a video output port.

19. The system of claim 17, wherein the HID interface is further configured to provide the HID notifications in response of detecting a disconnect or a connect at the video port of the docking station.

20. The system of claim 17, wherein the HID interface is further configured to receive a HID notification associated with a user selection of a video format by the online communication application.
